(19) United States
(12) Patent Application Publication
(10) Pub. No.: US 2015/0285407 A1
(43) Pub. Date: Oct. 8, 2015

(54) SUPPORT ELEMENT FOR SUPPORTING AT LEAST ONE CONDUIT IN AN AIRCRAFT, AND CORRESPONDING SUPPORT DEVICE

(71) Applicants: Airbus Operations (SAS), Toulouse (FR); Airbus (SAS), Blagnac (FR)

(72) Inventors: Benoit Aragon, Nailloux (FR); Nicolas Mignozzi, Toulouse (FR)

(21) Appl. No.: 14/681,258

(22) Filed: Apr. 8, 2015

(30) Foreign Application Priority Data
Apr. 8, 2014 (FR) 1453118

(51) Int. Cl. F16L 3/24; F16L 3/02

(52) U.S. Cl. CPC F16L 3/24; F16L 3/02

(57) ABSTRACT

A support element for at least one conduit, comprising a support portion for supporting conduits, and a clamp portion having an internal surface shaped to at least partially surround the perimeter of a rail. The clamp portion comprises a peg projecting from said internal surface and configured to be introduced into a corresponding hole in the rail when the clamp portion surrounds the perimeter of the rail.

### CROSS-REFERENCES TO RELATED APPLICATIONS

This application claims the benefit of the French patent application No. 1453118 filed on Apr. 8, 2014, the entire disclosures of which are incorporated herein by way of reference.

### BACKGROUND OF THE INVENTION

The present invention relates to a support element for supporting at least one conduit, such as a pipe or an electric cable, allowing it to be attached to the structure of an aircraft.

The invention also relates to a support device for supporting at least one conduit in an aircraft, implementing such a support element.

A great many conduits run through the structure of an aircraft. The term “conduit” in the present application refers with equal preference to pipes aimed at transporting a fluid from one point in the aircraft to another or cables or bundles of cables, such as electric cables, optical fibers, or the like, aimed at conveying power or a signal from one point in the aircraft to another. These various conduits need to be secured to the structure of the aircraft, in order to avoid any unwanted movement. This is because the safety regulations on board an aircraft forbid conduits from coming into contact with certain parts of the aircraft which could damage them.

In certain regions of the structure of the aircraft, rails, often made of metal, are provided to act as a support to which the conduits can be attached. The safety standards dictate on the one hand that the conduits attached to these rails be prevented from turning around the rails and, on the other hand, that these conduits be held away from these rails. In order to meet these standards, support elements clamping the conduits have to be fixed on mounting plates which are themselves welded to the rails.

Such a solution is effective but entails the use of special-purpose rails, carrying welded mounting plates, the cost of manufacture of which is relatively high. Moreover, it imposes the use of rails and support elements, the types of which differ according to the position and orientation of the conduit with respect to the rail and/or to the mounting plate. The number of types of rails and support elements required for manufacturing an aircraft is consequently high, making assembly of an aircraft more complicated and increasing the cost thereof.

### SUMMARY OF THE INVENTION

It is an objective of the present invention to alleviate the disadvantages of the prior art.

In particular, it is an objective of the invention to provide a solution to the attaching of the conduits to the structure of the aircraft which is simpler and less expensive to implement than the solutions of the prior art.

This objective, together with others which will become more readily apparent hereinafter, are achieved using a support element for at least one conduit, comprising:

a support portion for supporting said conduit or conduits; and

a clamp portion, having an internal surface shaped to at least partially surround the perimeter of a rail;

in which the clamp portion comprises a peg, projecting from the internal surface. This peg is able to be introduced into a corresponding hole in the rail when the clamp portion is surrounding the perimeter of the rail, and blocks the position of the support element on the rail.

Thus, when the clamp portion is surrounding the perimeter of the rail, the peg introduced into the hole in the rail blocks the sliding of the support element along the rail and the rotation thereof about the rail. The support element can thus be secured to the rail in an effective way, ensuring the position of the conduit or conduits with respect to the rail, while at the same time requiring only a very simple adaptation of the rail: a simple hole.

According to one embodiment, the internal surface has the shape of a portion of the surface of a cylinder of revolution, able partially to surround the perimeter of a rail of cylindrical section.

According to another embodiment, the internal surface has at least two portions forming right angles between them, which are able partially to surround the perimeter of a rail of rectangular section.

Advantageously, the internal surface is shaped to surround at least half the perimeter of the rail, the clamp portion being elastically deformable.

This embodiment allows the conduits to be installed quickly and easily in the aircraft. Thus, the support element can be fitted to the rail by deforming the clamp portion thereof. Once in place, the fact that the clamp portion returns elastically to its original shape and because it surrounds the rail over more than half of the perimeter thereof, the support element is effectively held in place.

According to one advantageous embodiment, the support portion and the clamp portion are connected to one another by a mobile connection allowing the support portion to adopt at least two distinct positions with respect to the clamp portion.

Thus the support element may adopt various configurations in which the support portion has different positions or orientations with respect to the clamp portion and therefore with respect to the rail.

According to another advantageous embodiment, the support portion and the clamp portion are connected to one another by a bar that maintains a predetermined distance between said portions.

Thus it is possible in an effective way to keep control over the distance between the rail and the conduit, for example in order to avoid contact.

According to another advantageous embodiment, the clamp portion comprises an internal ring exhibiting the internal surface and an external shell connected to the support portion, the internal ring and the external shell having means of mutual assembly allowing them to be secured to one another in at least two distinct positions.

Thus, the support element may adopt various configurations in which the support portion has different positions or orientations with respect to the internal ring and therefore with respect to the rail.

The invention also relates to a support device for at least one conduit in an aircraft, comprising a rail secured to the structure of the aircraft, a hole being drilled or formed in the surface of said rail, the support device also comprising a support element according to one of the alternative forms described hereinabove, of which the internal surface at least partially surrounds the perimeter of the rail, and of which the peg enters the hole drilled in the surface of the rail.

Such a device allows conduits to be attached in the aircraft using rails that are simple, inexpensive, and which can easily be standardized.

Advantageously, in this device, the clamp portion has at least two attachment points for a flexible tie, and the device comprises at least one flexible tie connecting said attachment points such that the assembly formed by said clamp portion and said flexible tie completely surrounds the rail.

Advantageously, in this device, the support portion has at least two attachment points of a flexible tie, and the device comprises at least one flexible tie connecting the attachment points in such a way as to attach at least one conduit to the support portion.

### BRIEF DESCRIPTION OF THE DRAWINGS

The invention will be better understood from reading the following description of some preferred embodiments, given by way of nonlimiting illustration and accompanied by figures among which:

FIG. 1 depicts a support element according to a first embodiment of the invention;

FIG. 2 depicts the support element of FIG. 1 assembled on a rail of an aircraft;

FIG. 3 depicts a support element according to a second embodiment of the invention, assembled on a rail of an aircraft;

FIG. 4 depicts a support element according to a third embodiment of the invention, assembled on a rail of an aircraft;

FIG. 5 depicts a support element according to a fourth embodiment of the invention, assembled on a rail of an aircraft;

FIG. 6 depicts a support element according to a fifth embodiment of the invention;

FIG. 7 depicts an internal ring of the support element of FIG. 6, assembled on a rail of an aircraft;

FIG. 8 depicts an outer shell of the support element of FIG. 6;

FIG. 9 depicts the support element of FIG. 6, assembled on a rail of an aircraft in a first possible configuration;

FIG. 10 depicts the support element of FIG. 6, assembled on a rail of an aircraft in a second possible configuration.

### DETAILED DESCRIPTION OF THE PREFERRED EMBODIMENTS

According to the invention, conduits passing through the aircraft are assembled with rails secured to the structure of the aircraft by support elements which comprise a peg intended to be introduced into a corresponding hole in the rail. This peg allows correct positioning of the support element with respect to the rail to be ensured, preventing this element from turning around the rail or from sliding along the latter.

Moreover, this solution, for ensuring correct positioning of the conduits with respect to the rail, requires only a drilling in this rail, which is far less expensive to produce than the welded attachment of a mounting plate.

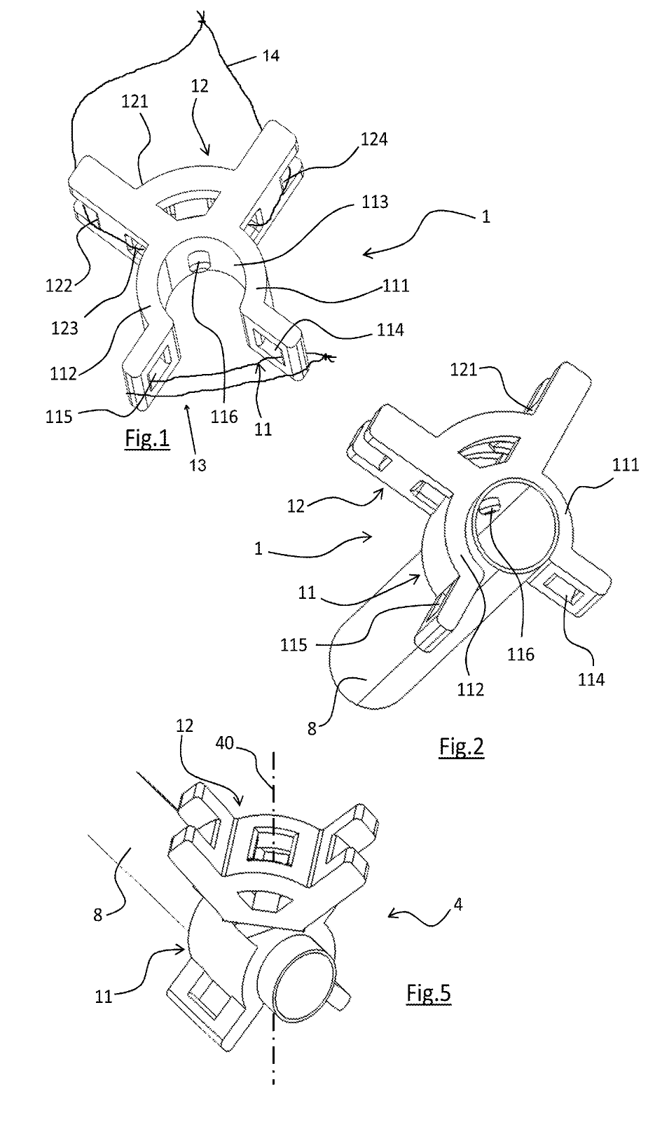

FIGS. 1 and 2 depict a support element 1 according to a first possible embodiment of the invention which, in FIG. 2, is assembled on a rail 8 of an aircraft. The rail 8 comprises, in the conventional way, a portion of metal tube of circular section. The support element 1 is made up of a clamp portion 11, intended to be secured to the rail 8, and of a support portion for supporting at least one conduit 12.

The clamp portion 11 is made up of two tabs 111 and 112 together forming an internal surface 113 intended partially to surround the rail 8. The shape of this surface, extending over an angular portion of a cylinder of revolution, allows it to partially hug the cylindrical external surface of the rail 8, preferably over more than half of the perimeter thereof. As a result, the conduit-support element 1 has to be fitted onto the rail 8 by elastically deforming the tabs 111 and 112 which, because they return to their position after having been deformed, therefore allow the support element 1 to be held in position on the rail 8, as FIG. 2 shows.

In order to guarantee that this position is maintained even when the support element is under load, the free ends of the tabs 111 and 112 bear attachment points 114 and 115 respectively, which are formed of openings through which a flexible tie 13 can be passed to connect these two attachment points 114 and 115. When the clamp portion 11 is mounted on a rail, as FIG. 2 shows, and the flexible tie 13 is connecting its attachment points 114 and 115, the assembly formed by the clamp portion 11 and the flexible tie 13 completely surrounds the rail 8 so that the clamp portion 11 cannot be removed from the rail 8.

According to the invention, the clamp portion 11 of the support element 1 has a locating peg 116 projecting from its surface 113 intended to come into contact with the rail 8. This locating peg 116 is intended to enter a corresponding hole made in the rail 8, so as to block the position of the support element 1 with respect to the rail 8. What happens is that insertion of this peg 116 in the corresponding hole in the rail, the diameter of which is slightly greater than the diameter of the peg 116, blocks the translational movement of the support element 1 along the rail 8, in the longitudinal direction thereof, and the rotation thereof about the rail 8.

The support element 1 also comprises a support portion 12 for supporting at least one conduit. This support portion 12, which is known per se, has walls 121 forming a cradle able to accept one or more conduits running in a determined direction. This support portion 12 comprises or may accept attachment means allowing the conduits to be blocked in the cradle. In the embodiment depicted, the conduit support portion 12 comprises passage zones 122, 123 and 124 that allow the fitting of a flexible tie 14 able to clamp the conduits and the part of the conduit support portion 12 comprising the cradle-forming walls 121, so as to keep the conduits in contact with these cradle-forming walls. The passage zones 122, 123 and 124 and the flexible tie 14 form attachment means that allow the conduits to be blocked in the cradle.

The conduit support element 1 therefore allows control over the position of the conduits with respect to the structure of the aircraft, which structure here comprises the rail 8. In particular, this support element 1 allows the conduits to be kept some distance away from the rail 8 and prevents them from pivoting about the longitudinal axis of the rail 8, so as to meet the requirements of the relevant standards. This control over the position of the conduits with respect to the rail may be had without significant modification to the rail, the only modification required being the presence of a hole, at the surface of the rail, the position of which determines the position of the support element 1.

According to an alternative form of embodiment depicted in FIG. 4, the conduit support portion 32 is designed to support a large-diameter conduit, positioned a greater distance away from the rail. For that purpose it has two tabs 321 and 322 which are intended to partially surround the conduit, hugging the surface thereof over more than half of its perimeter. As a result, the conduit can be fitted in the support portion 32 by elastic deformation of the tabs 321 and 322 which, by returning to their position after having been deformed, thus allow the conduit to be held in position. The tabs can then be held in position by a flexible tie clamping the two free ends 323 and 324 of the tabs 321 and 322.

The conduit support element 3 comprises this support portion 32, connected to a clamp portion 11, identical to that of the support element 1, by a bar 325, the length and shape of which are determined so as to position the conduit in the desired position with respect to the rail 8.

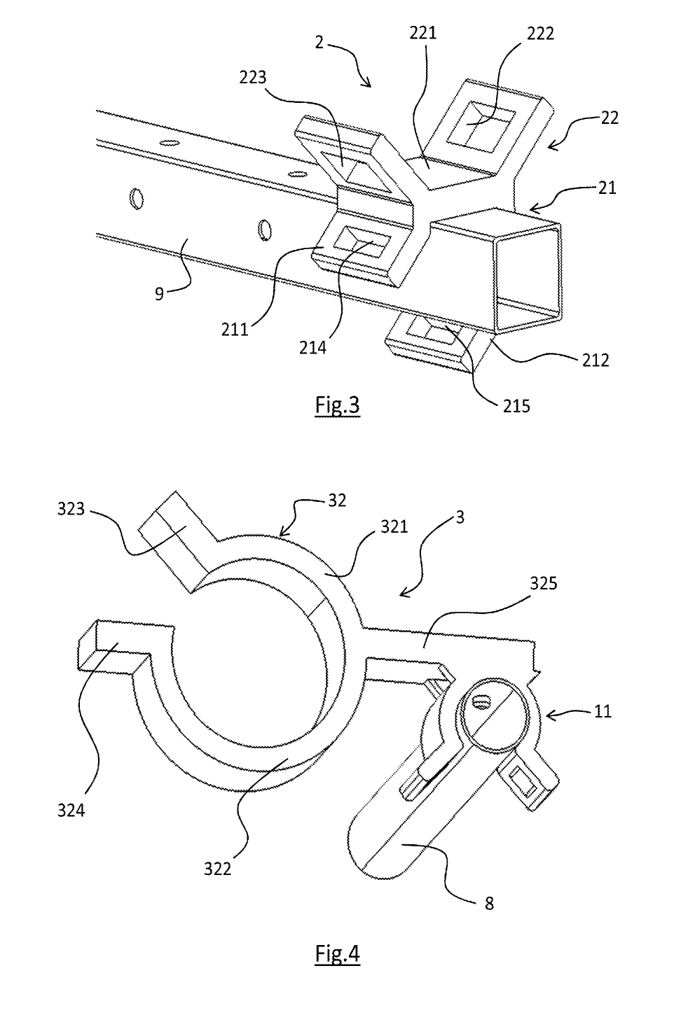

FIG. 3 depicts a conduit support element 2 according to another possible embodiment of the invention, assembled on a rail 9 of an aircraft. In this embodiment, the rail 9 comprises a portion of metal tube which, unlike the tube of the rail 8, has a square section. Like the support element 1 described hereinabove, the support element 2 comprises a clamp portion 21, intended to be secured to the rail 9, and a conduit support portion 22.

The clamp portion 21 is made up of two tabs 211 and 212 which together form an internal surface having the shape of a portion of the perimeter of the rail 9, so as to hug the surface of the rail over more than half of the perimeter thereof. This support element 2 may be fitted onto the rail 9 by elastically deforming the tabs 211 and 212 which, returning to their position after having been deformed, allow the support element 2 to be held in position as FIG. 3 shows.

In addition, the free ends of the tabs 211 and 212 bear attachment points, 214 and 215 respectively, which comprise openings allowing the passage of a flexible tie (not depicted in FIG. 3) that connects the two attachment points 214 and 215. When the clamp portion 21 is mounted on a rail 9, as depicted in FIG. 2, and a flexible tie is connecting its attachment points 214 and 215, the assembly formed by the clamp portion and the flexible tie completely surrounds the rail 9 so that it cannot be removed from the rail.

According to the invention, the clamp portion 21 of the conduit support element 1 has a locating peg on its surface intended to come into contact with the rail 9. This locating peg (not visible in FIG. 3) is intended to enter a corresponding hole of a diameter slightly greater than the diameter of the peg, provided in the rail 9. Its insertion into the hole in the rail blocks the translational movement of the support element 2 along the rail 9 in the longitudinal direction thereof.

The support element 2 also comprises a conduit support portion 22. This support portion, similar to that of the support element 1 described hereinabove, has cradle-forming walls 221 and passage zones 222 and 223 allowing the fitting of a flexible tie (not depicted in FIG. 3) able to keep one or more conduit(s) in contact with these cradle-forming walls 221.

It should be noted that the rail 9 has a plurality of holes pierced uniformly all along its length, on a number of its faces. Such a rail can easily be used for attaching a support element 2 in a great many positions, without the need for adaptation.

According to yet another alternative form of embodiment depicted in FIG. 5, the conduit support element 4 comprises a clamp portion 11 and a portion 12 for supporting at least one conduit, these portions being assembled with the ability to rotate with respect to one another about an axis 40 perpendicular to the plane of connection between these two portions. A person skilled in the art will have no difficulty in implementing such a connection, for example using a spiked peg borne by one of the portions and introduced, with elastic deformation, into a correspondingly shaped opening provided in the other portion. If the surfaces for contact between the two portions are planar and perpendicular to the axis of this peg, the portions can then pivot relative to one another about this axis, but have no further degrees of freedom.

It is also possible, in another alternative form, to provide for the connection between the two portions to block this pivoting. In such a case, when the two portions have been assembled in the desired angular position, there is no longer any possibility of changing their position. A person skilled in the art will easily know how to implement this solution, for example by providing grooves on the surfaces for contact between the two portions.

These embodiments advantageously allow a rail 8 to be attached to a conduit that is to run in a direction that makes an arbitrary angle with the rail, while at the same time using a support element of a standard type.

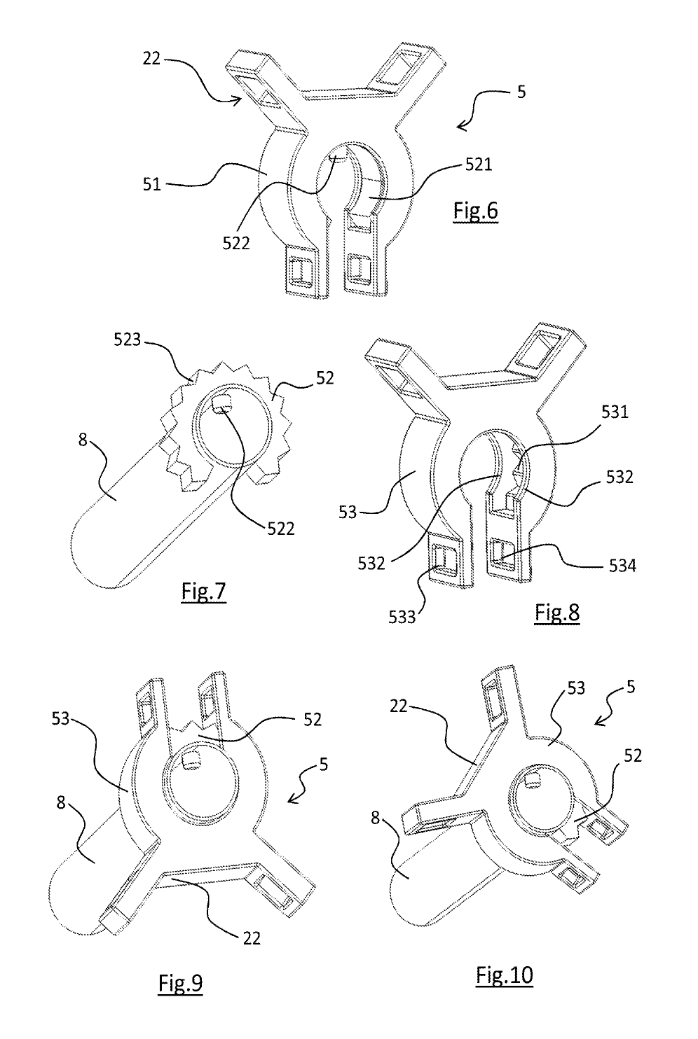

FIGS. 6 to 10 depict a conduit support element 5 according to another possible embodiment of the invention. It comprises a conduit support portion 22 identical to that of the conduit element 2 described hereinabove, and a clamp portion 51 which is intended to be secured to the rail 8. The clamp portion 51 is made up of an internal ring 52 which is depicted mounted on the rail 8 in FIG. 7, and an external shell 53.

The internal ring 52 takes the form of an open annulus, the internal surface 521 of which has a shape allowing it to hug the external surface of the rail over more than half of the perimeter thereof. The internal ring 52 can thus be fitted over the rail 8, with elastic deformation, and be held in position on the rail as FIG. 7 shows.

According to the invention, the internal ring 52 has a locating peg 522 projecting from its internal surface 521 intended to come into contact with the rail 8. This locating peg 522 is intended to enter a corresponding hole provided in the rail 8, so as to block translational movement of the internal ring 52 along the rail 8 in the longitudinal direction thereof and the rotation of same about the rail 8. The external surface 523 of the internal ring 52 forms a series of teeth evenly distributed over its perimeter.

The external shell 53 has two tabs connected to the conduit support portion 22 and forming an internal surface 531 which are intended partially to envelope the internal ring. This internal surface 531 has teeth of a shape that complements those of the external surface 523 of the internal ring 52. The external shell 53 can therefore, by undergoing elastic deformation, be positioned on the internal ring 52. The external shell 53 is therefore blocked against rotation with respect to this ring about the axis of the rail by the collaboration between the teeth of the surface 531 and of the surface 523. Furthermore, the external shell 53 is also blocked against translational movement by the collaboration of lateral margins 532 of the external shell 53 with the edges of the internal ring 52. When the external shell 53 is in position on the internal ring 52, as depicted in FIG. 6, these two elements are therefore completely secured to one another.

According to this embodiment of the invention, the external shell 53 may be fitted over the internal ring 52 in a plurality of angular positions, the teeth on the surfaces in contact collaborating to block the components in this position. Thus, FIGS. 9 and 10 depict the conduit support element 5 mounted on the rail 8 in two distinct configurations in which the external shell 53, and therefore the support portion 22 associated with it, are in different angular positions with respect to the rail 8.

The position of the shell 53 on the ring 52 can be locked by the fitting of a flexible tie that connects the attachment elements 533 and 534 present at the free ends of the tabs forming the outer shell 53. It is thus possible to lock the position of the support element 5 with the conduit support portion 22 oriented in the desired angular position with respect to the rail 8. This embodiment therefore makes it possible to support a conduit near the rail 8, which is positioned in a desired position with respect to this rail, independently of the angular position of the drilling into which the peg 522 can be inserted.

A person skilled in the art will quite obviously be able to implement alternative forms of the embodiments described, for example by combining the features of the various embodiments or by making the clamp portion compatible with the shape of rails of different types.

The use of a conduit support element according to one of the embodiments of the invention thus makes it possible to hold a conduit, which may be a pipe, an electric cable, a bundle of optical fibers or any other type of conduit, in the desired position with respect to a rail. This rail may itself be of very simple design, a hole in the rail being enough to allow the conduit support element to be positioned accurately. According to one possible embodiment, such a hole may be drilled in the rail in a predefined position for the fitting of a conduit support element. According to another possible embodiment, a rail with uniform drillings may be used. This embodiment advantageously allows the use of standardized rails, the cost of manufacture of which is consequently very low.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A support element for at least one conduit, comprising:
a support portion configured to support said conduit or conduits; and
a clamp portion having an internal surface shaped to at least partially surround a perimeter of a rail;
the clamp portion comprising a peg projecting from said internal surface.

2. The support element as claimed in claim 1, wherein said internal surface has a shape of a portion of a surface of a cylinder of revolution, configured to partially surround the perimeter of a cylindrical section of the rail.

3. The support element as claimed in claim 1, wherein said internal surface has at least two portions forming right angles between them, the portions being configured to partially surround the perimeter of a rectangular section of the rail.

4. The support element as claimed in claim 1, wherein said internal surface is shaped to surround at least half of a perimeter of said rail, and wherein said clamp portion is elastically deformable.

5. The support element as claimed in claim 1, wherein said support portion and said clamp portion are connected to one another by a mobile connection allowing said support portion to adopt at least two distinct positions with respect to said clamp portion.

6. The support element as claimed in claim 1, wherein said support portion and said clamp portion are connected to one another by a bar that maintains a predetermined distance between said portions.

7. The support element as claimed in claim 1, wherein said clamp portion comprises an internal ring having said internal surface and an external shell connected to said support portion, said internal ring and said external shell having means of mutual assembly allowing them to be secured to one another in at least two distinct positions.

8. The support element as claimed in claim 1, wherein said clamp portion comprises an internal ring having said internal surface and an external shell connected to said support portion, said internal ring and said external shell having complementary surface configurations allowing them to be secured to one another in at least two distinct positions.

9. A support device for at least one conduit in an aircraft, comprising:
a rail secured to a structure of the aircraft,
said rail including a hole formed through a surface of said rail, and
a support element for the at least one conduit, the support element comprising:
a support portion configured to support said at least one conduit; and
a clamp portion having an internal surface shaped to at least partially surround a perimeter of a rail;
the clamp portion comprising a peg projecting from said internal surface,
the internal surface at least partially surrounding the perimeter of said rail, and
the peg projecting into said hole.

10. The support device as claimed in claim 9, wherein said clamp portion has at least two attachment points for a flexible tie, and wherein said device comprises at least one flexible tie connecting said attachment points, such that the assembly formed by said clamp portion and said flexible tie completely surrounds said rail.

11. The support device as claimed in claim 9, wherein said support portion has at least two attachment points for a flexible tie, and wherein said device comprises at least one flexible tie connecting said attachment points in such a way as to attach at least one conduit to said support portion.
